(19) United States
(12) Patent Application Publication
(10) Pub. No.: US 2024/0211981 A1
(43) Pub. Date: Jun. 27, 2024

(54) SYSTEMS AND METHODS FOR DATA SET EVALUATION

(71) Applicant: DataAppraisal, Inc., OverlandPark, KS (US)

(72) Inventors: Nghi (Roger) Hoai NGO, Parkville, MO (US); Tam Minh TRAN, Overland Park, KS (US)

(73) Assignee: DataAppraisal, Inc., Overland Park, KS (US)

(21) Appl. No.: 18/107,829

(22) Filed: Feb. 9, 2023

Related U.S. Application Data
(60) Provisional application No. 63/435,506, filed on Dec. 27, 2022.

(51) Int. Cl. G06Q 30/0201

(52) U.S. Cl. CPC G06Q 30/0206

(57) ABSTRACT

Systems and methods directed to evaluating data sets include a master data evaluation model that is maintained at a central data evaluation system and dynamically updated based on data set transaction information. Local instances of the master data evaluation model can be maintained on secondary computing systems to permit evaluation of data sets stored on the secondary systems while preserving data security and resources. The central data evaluation system is also configured to transmit data for instantiating and updating data evaluation models maintained in the secondary systems.

### CROSS-REFERENCE TO RELATED APPLICATIONS

This application claims benefit of U.S. Provisional Patent Application No. 63/435,506, which was filed Dec. 27, 2022, and titled “SYSTEMS AND METHODS FOR DATA SET EVALUATION”. The entire contents of the foregoing are incorporated herein by reference for all purposes.

### TECHNICAL FIELD

Aspects of the present disclosure are directed to evaluation of data sets including distribution and management of models for evaluating data sets.

### BACKGROUND

Data is an increasingly important and valuable asset in the modern economy. Despite its importance, evaluating and appraising data in an accurate and meaningful way remains a substantial challenge. Among other things, the market for data is notoriously dynamic such that an evaluation of a data set on a given day can quickly become outdated and minimally useful in marketing and monetizing the data set.

The systems and methods provided in this disclosure were conceived with at least the foregoing challenges related to evaluating data sets in mind.

### SUMMARY

In some aspects, the techniques described herein relate to a computer-implemented method that includes transmitting an update to a data evaluation model from a first computing system maintaining a master of the data evaluation model. The data evaluation model is configured to generate evaluation metrics for data sets, and the update includes a change in a parameter of the data evaluation model. When received by a second computing system maintaining an instance of the data evaluation model, the update causes the second computing system to apply the change to the parameter in the instance of the data evaluation model.

In another aspect this disclosure provides a computer system including one or more data processors and a non-transitory computer-readable storage medium containing instructions. When executed by the one or more data processors, the instructions cause the one or more data processors to perform operations including transmitting an update to a data evaluation model from a first computing system maintaining a master of the data evaluation model. The data evaluation model is configured to generate evaluation metrics for data sets, and the update includes a change in a parameter of the data evaluation model. When received by a second computing system maintaining an instance of the data evaluation model, the update causes the second computing system to apply the change to the parameter in the instance of the data evaluation model.

In another aspect, the techniques described herein relate to a computer-program product tangibly embodied in a non-transitory machine-readable storage medium, including instructions configured to cause a computing device to perform operations including transmitting an update to a data evaluation model from a first computing system maintaining a master of the data evaluation model. The data evaluation model is configured to generate evaluation metrics for data sets, and the update includes a change in a parameter of the data evaluation model. When received by a second computing system maintaining an instance of the data evaluation model, the update causes the second computing.

### BRIEF DESCRIPTION OF THE FIGURES

FIG. 1 a diagram of a computing environment including a data evaluation system according to the present disclosure.

FIG. 2 is a block diagram illustrating a data evaluation module of the data evaluation system of FIG. 1 in further detail.

FIG. 3 is a flowchart illustrating a method for evaluating a data set.

FIG. 4 is a diagram of a computing environment illustrating a distributed implementation of a data evaluation system.

FIG. 5 is a flowchart illustrating a method for updating instances of data evaluation models in response to updating a master data evaluation model.

FIG. 6 is a flowchart illustrating a method for updating an instance of a data evaluation model based on an update to a master data evaluation model.

FIG. 7 is a block diagram illustrating an example of a computing device or computer system which may be used in implementations of the present disclosure.

### DESCRIPTION

Aspects of the present disclosure are directed to systems and methods for accurately and dynamically evaluating data sets. Implementations of this disclosure generally include a data evaluation system that maintains and updates one or more data evaluation models for providing evaluation metrics for data sets. The data evaluation models generally receive input data, which may include metadata describing the data set being evaluated and data set-independent data, such as economic data. Based on the input data, the data evaluation models output an evaluation metric value which, in certain cases, may be an estimated monetary value for the data set or a non-monetary score or rating of the data set.

To ensure that the output of the data evaluation models accurately reflects market sentiment, the data evaluation system is configured to obtain transaction data, e.g., from a data marketplace, and to use the transaction data as training data for the data evaluation models.

In certain implementations, the analysis is performed by the data evaluation system. For example, the data evaluation system may receive a copy of the data set to be evaluated, extract metadata from the data set, collect any required external data, and execute one or more data evaluation models maintained by the data evaluation system to evaluate the data set.

In other implementations, and particularly those in which data privacy and security may be a concern, the data evaluation system may be part of a distributed architecture. In the distributed architecture, the data evaluation system maintains master versions of data evaluation models while data host systems (e.g., systems that store, maintain, or otherwise have access to data sets to be evaluated) maintain local instances of one or more of the master data evaluation models. The data evaluation system updates the master version of the data evaluation models (e.g., based on evaluation data received from the data host systems and/or transaction data obtained by the data evaluation system) and distributes updated model parameters to the data host systems such that the instances of the models maintained by the data host systems are current. In certain implementations, the data evaluation system also archives previous versions of the master data evaluation models, e.g., to facilitate recreating prior evaluations or simulating historic values for data sets.

The foregoing aspects of the present disclosure, among others, are now described in further detail with reference to the figures.

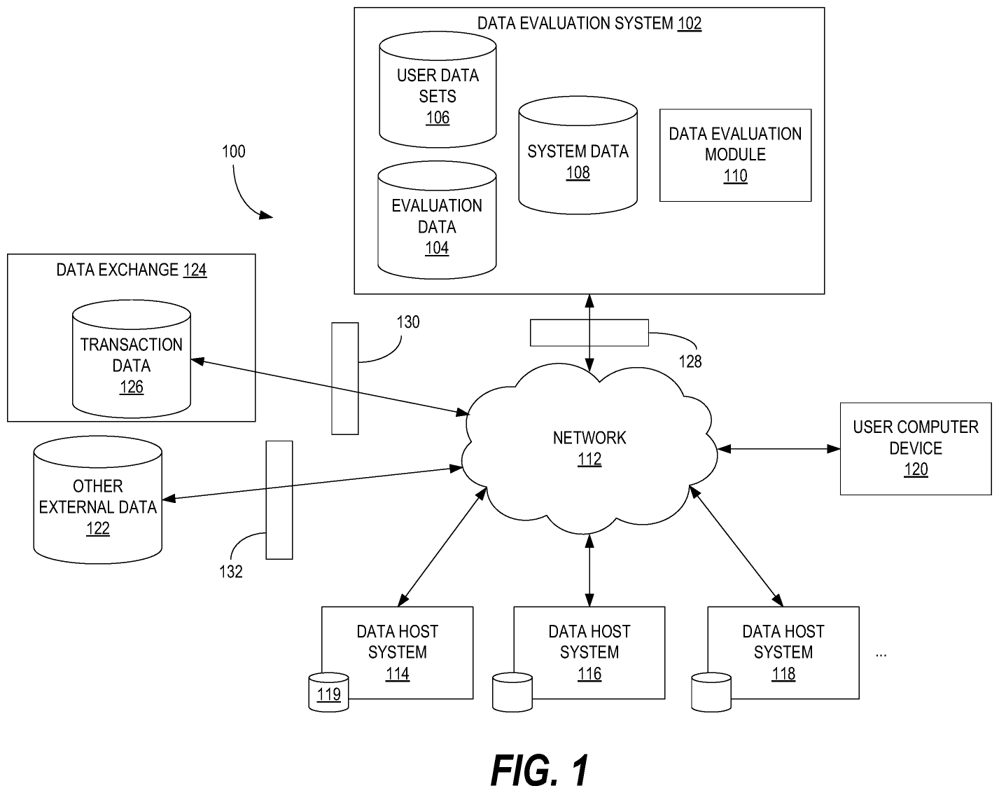

FIG. 1 illustrates an environment 100 including a data evaluation system 102 according to the present disclosure. As described below in further detail, data evaluation system 102 receives data sets and performs an evaluation of the received data sets using one or more data evaluation models. The models of data evaluation system 102 rely on a variety of inputs including, but not limited to, metadata for the received data sets, information provided by the owner/user associated with the data sets, and external data (e.g., externally maintained economic data). Data evaluation system 102 is also configured to update its data evaluation models automatically and dynamically, e.g., using transaction data from data exchanges or marketplaces that reflect current market sentiment and valuation trends.

In the illustrated implementation, data evaluation system 102 is in communication with data host system 114, data host system 116, and data host system 118 over a network 112 (which is intended as a general representation of any suitable communication network, e.g., the Internet, and may include one or more interconnected networks or subnetworks). In other implementations, data evaluation system 102 may be in communication with or be otherwise accessible by any suitable number of data host systems. For simplicity, the following discussion makes reference to data host system 114. Unless otherwise indicated, features and functions of data host system 114 are generally applicable to data host system 116, data host system 118 and any other data host system that may be configured to communicate and operate with data evaluation system 102.

Each data host system stores, provides access to, or has access to one or more user data sets. For example, data host system 114 is associated with user data set 119. During operation, data evaluation system 102 receives user data set 119. In certain implementations, data evaluation system 102 receives data set 119 by requesting data set 119 from data host system 114. Alternatively, data host system 114 may initiate transmission of data set 119 to data evaluation system 102 as part of an evaluation request. In still other implementations, data evaluation system 102 may have direct access to data set 119 and may receive data set 119 by performing a data set retrieval operation. When received, data evaluation system 102 stores data set 119 in user data sets data source 106. Alternative implementations in which data set 119 is maintained at data host system 114 are provided later in this disclosure.

In certain implementations, data evaluation system 102 receives data set 119 in its entirety. Alternatively, data evaluation system 102 may be configured to receive an initial version of data set 119. Subsequently, data evaluation system 102 but may be configured to receive only updates to data set 119 from data host system 114. For example, as records are added, deleted, or modified, data host system 114 may maintain a change log or change records in a database. Periodically, prior to evaluating data set 119, or in response to some other condition, data evaluation system 102 may retrieve the change log or change records from data host system 114 and apply the changes to the copy of data host system 118 stored in user data sets data source 106. Among other things, transferring only updates results in reduced bandwidth and processing requirements as compared to transferring data set 119 in its entirety.

When data evaluation system 102 receives data set 119 or an update to data set 119, data evaluation system 102 may perform a pre-evaluation analysis of data set 119. Pre-evaluation analysis of data sets is discussed below in further detail; however, in general, data evaluation system 102 analyzes and extracts various quantitative and/or qualitative characteristics of the data set (e.g., size of the data set, recency of records included in the data set, consistency). Data evaluation system 102 may then store the extracted data in a corresponding data source, e.g., evaluation data source 104, in a manner linked to or otherwise associated with data set 119.

In addition to data extracted from data set 119, data evaluation system 102 may also receive or obtain other data for use in evaluating data set 119. For example, a user associated with data host system 114 may provide details or information that may not be otherwise extractable from data set 119. By way of non-limiting example, a user may provide a cost estimate or target price for data set 119, a cost of acquiring the data set, or an industry/vertical/sector relevant to the data set or user, characteristics of the business associated with the user (e.g., annual revenues/profits, etc.), or the results of historic monetization efforts related to the data (e.g., prior sales of the data set or licensing of the data set) and information regarding the data set at the time of monetization. In certain implementations, the user may be prompted to provide such data when creating an account or setting up an application corresponding to data evaluation system 102. In other implementations, the user may be prompted to provide the additional information when requesting an evaluation. The supplemental information provided by the user may be stored with or in a manner associated or linked with data set 119 in user data sets data source 106 or other data source for access and use by data evaluation system 102.

In general, this disclosure refers to data describing or characterizing a given data set as metadata for that data set. As noted above, metadata for a given data set may be stored in evaluation data source 104 in a manner associated with data set 119.

In contrast to metadata, data evaluation system 102 may also obtain or otherwise receive external data, e.g., from external data source 122. In at least one example, external data source 122 may include sources of economic data, such as interest rates or inflation rates, which are generally unrelated directly to the data sets being evaluated but can be important in determining pricing and valuation metrics.

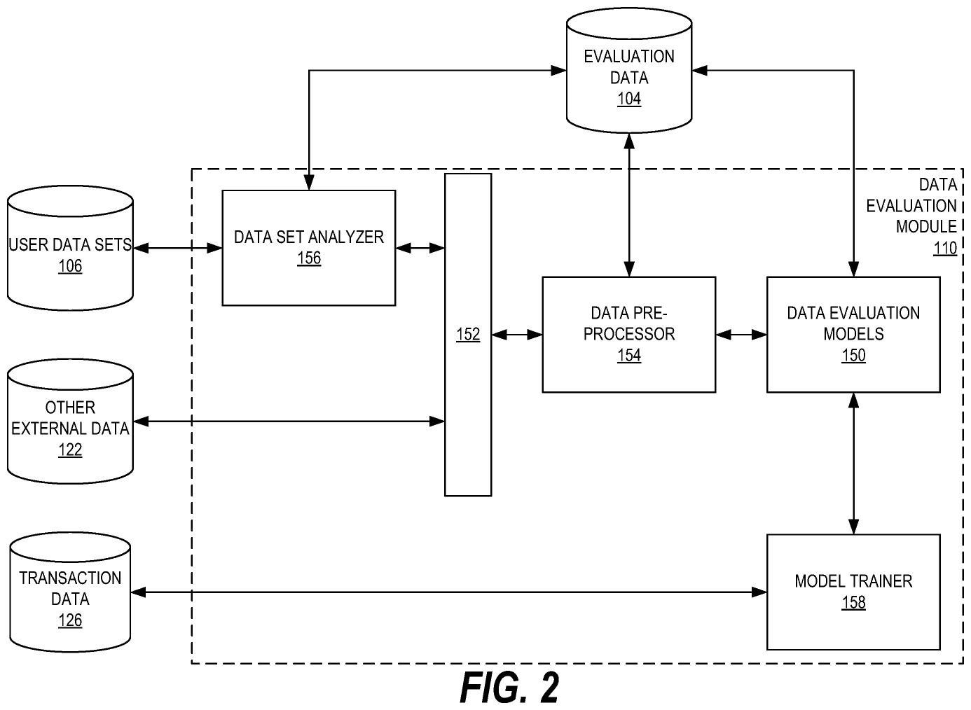

To evaluate data set 119, data evaluation system 102 provides input data including the metadata associated with data set 119 along with any relevant external data to a data evaluation module 110. In some implementations, the input data may also include some or all of data set 119. As described further in the context of FIG. 2, data evaluation module 110 may include various filters, pre-processors, and similar components for preparing the input data provided to data evaluation module 110. The pre-processed input data is then provided to one or more data evaluation models. The data evaluation models receive the input data and provide an evaluation of the associated data set as an output. Data evaluation module 110 may then store the evaluation in evaluation data source 104, transmit the evaluation to data host system 114, present the evaluation to a user associated with data host system 114 (e.g., through a website, application, or similar software), generate and transmit an evaluation report to a list of recipients, or otherwise make the evaluation available. In at least certain implementations, the output of the evaluation generated by the data evaluation models may be stored in a record or in a manner associated with some or all of the input data. So, for example, following evaluation of a given data set, data evaluation module 110 may create a record including the result of the evaluation (e.g., a dollar value for the data set), at least a subset of the metadata and external data relied on by the data evaluation models, and a timestamp indicating when the evaluation was conducted.

The output of data evaluation module 110 may vary across implementations of this disclosure. By way of non-limiting example, data evaluation module 110 may output an estimated monetary value for the data set (e.g., a cost to purchase, access, or license the data set). As another example, data evaluation module 110 may output a score (e.g., a letter grade, a numerical score, a percentage score, a “star” rating, etc.) for the data set. More generally, data evaluation module 110 outputs some qualitative measure of the evaluated data set, which may be subsequently used for marketing and monetization efforts for the data set.

To ensure that data evaluation module 110 provides accurate and meaningful results, data evaluation system 102 is configured to obtain actual data set transaction data and to train the models of data evaluation module 110 according to the transaction data. For example, in FIG. 1, data evaluation system 102 communicates with a data exchange 124 over network 112 to obtain transaction data from data exchange 124, e.g., from transaction data source 126 of data exchange 124. Among other things, transaction data may include metadata or other data associated with a data set for which one or more transactions (e.g., a sale, license, etc.) occurred on data exchange 124, external data collected at the time of the one or more transactions, an evaluation metric for the data set, and date/time information describing when the one or more transactions occurred. In certain implementations, the evaluation metric may be a monetary value for a transaction of the data set or user ratings of the data set.

Following acquisition of transaction data, data evaluation system 102 may use the transaction data as training data for its various models. For example, the various pieces of metadata and external data corresponding to a transaction provides a feature set while the evaluation metric provides an output corresponding to the feature set. As a result, the transaction data can be used to train and update models of data evaluation system 102, e.g., by modifying various parameters, weightings, coefficients, etc., of the models of data evaluation system 102. By regularly obtaining new transaction data and updating its models using new transaction data as training data for its models, data evaluation system 102 can remain current and dynamically change to reflect market conditions and trends as captured in the transaction data.

As previously noted, the data evaluation models of data evaluation module 110 may rely, in part, on external data, such as economic data, interest rates, etc. Given that such data varies over time, generating training data for the data evaluation models may include retrieving economic data contemporaneous with the transactions included in the transaction data. For example, when generating training data for a given transaction, data evaluation system 102 may determine the date/time of the transaction (e.g., by retrieving a timestamp included in the transaction data). This time information may then be used to access or retrieve a historical value for one or more economic metrics (e.g., from external data source 122) contemporaneous with the transaction. The historical values may then be incorporated into the training data such that the training process properly accounts for changes in external economic factors.

How and when data evaluation system 102 updates its models can vary across implementations. For example, in one implementation, data evaluation system 102 may be configured to periodically (e.g., hourly, daily, weekly) collect transaction data and update its models based on the collected data. In another example implementation, data exchange 124 may export transaction data on a time (e.g., every week), transaction quantity (e.g., every ten transactions), or other basis. Data evaluation system 102 may also be configured to collect and use transaction data from multiple data exchanges and/or support importing of spreadsheets, databases, or other formats of transaction data provided manually by a user.

Referring back to FIG. 1, in at least certain implementations, communication between data evaluation system 102 and the various other devices and systems included in environment 100 may be facilitated by one or more interfaces. For example, FIG. 1 includes an interface 128 to facilitate communication with data evaluation system 102, an interface 130 to facilitate communication with data exchange 124, and an interface 132 to facilitate communication with external data source 122. In at least certain implementations, interface 128, interface 130, and/or interface 132 may be in the form of an application programming interface (API), such as a REST API or HTTP API.

Although not shown, data host system 114 may include or be accessible by a user computing device through which a user may access features and functions of data evaluation system 102. For example, a user may access data evaluation system 102 through data host system 114 to upload data sets for evaluation, access information on previous evaluations, or to modify settings for the user. Similarly, a user may access data evaluation system 102 through a user computing device (e.g., user computing device 120) independent of any of the data host systems. For example, user computing device 120 may be a laptop, smartphone, tablet, desktop computer, or similar computing device on which a local or web-based application is executed to access data evaluation system 102. As shown in FIG. 1, data evaluation system 102 may include or have access to a system data source 108 in which data related to operation, access, configuration, etc. of data evaluation system 102 may be stored.

Generally speaking, data exchange 124 and transaction data maintained in transaction data source 126 provide feedback to data evaluation system 102 for refining and training the various models maintained by data evaluation system 102. For example, the price at which a data set is purchased or licensed from data exchange 124, time to purchase/license, and characteristics of the purchased/licensed data set may all provide training data for the models of data evaluation system 102.

Purchasing/licensing price is only one evaluation metric that may be provided by data exchange 124 as a means of feedback. By non-limiting example, data exchange 124 may alternatively or additionally provide details regarding the quantity of purchases/licenses for a given data set, the number of times a page for a given data set was accessed, or the number of times the data set or license for the data set was added to a purchase cart. Certain data exchanges may also generate or otherwise support evaluation metrics for data sets similar to but independent of data evaluation system 102. For example, data exchange 124 may include a separate set of data set evaluation algorithms or models that produce an evaluation metric similar to but independent of data evaluation module 110. As yet another example, data exchange 124 may permit purchasers or users to review or rate a given data set. Notably, each of the foregoing provides an evaluation of a data set independent of data evaluation system 102 and, as a result, can form the basis for training data by which data evaluation system 102 can refine its models.

Considering the foregoing, a data exchange where users can purchase or license data sets is provided as just one example of a feedback source for data evaluation system 102. More generally, any source of data that correlates data set characteristics to an evaluation metric for the data set may be relied upon for feedback by data evaluation system 102. For example, data evaluation system 102 may access a source of free or open source data sets for feedback. In such cases, a monetary value for a data set may not be available, but other data, such as a user rating or a number of downloads of the data set may be relied on instead. Accordingly, while this disclosure generally refers to data exchanges and similar marketplaces where data sets may be purchased or licensed, this disclosure contemplates that the concepts presented can be readily adapted to other applications, including non-monetary applications.

This disclosure also contemplates that data evaluation system 102 may receive feedback from multiple sources. For example, transaction data may be collected from multiple data exchanges and consolidated into a single set of training data by data evaluation system 102.

A given data set may be made available on multiple data exchanges or may be subject to multiple sales or licenses. In such cases, data evaluation system 102 may treat each such transaction as an independent piece of training data. Alternatively, data evaluation system 102 may generate transaction data based on summary statistics for the transactions. For example, data evaluation system 102 may generate training data based on the average sale or licensing prices for a data set. Similar summary statistics may be used to consolidate data set characteristics and external data that may change over time.

In certain cases, the feedback received by data evaluation system 102 may be in a different format than the evaluation metrics generated by data evaluation system 102. For example, data evaluation system 102 may generate an evaluation metric in the form of a score (e.g., a score from 0-100) while the feedback provided, e.g., by data exchange 124 may be in the form of a purchase price. Accordingly, data evaluation system 102 may include functionality for translating between different metrics or providing metrics in multiple styles and formats. So, for example, data evaluation system 102 may be configured to normalize a price for a data set to a score from 0-100 or vice versa for purposes of generating consistent training data or for providing multiple evaluation metrics.

In still other implementations, data evaluation system 102 may include multiple models or sets of models, each of which may be configured to generate an evaluation metric in a different format. For example, data evaluation system 102 may include a first model or sets of models for generating a monetary value for a data set and a second model or sets of models for generating a score or similar metric for the data set. In such cases, evaluating the data set may include executing each of the models/sets of models to produce multiple evaluation metrics.

Notably, transaction data and other feedback used by data evaluation system 102 to refine its models may or may not correspond to data sets that data evaluation system 102 previously evaluated provided that sufficient details regarding the data set and transaction are available. Nevertheless, in cases where transaction data is received for a data set evaluated by data evaluation system 102, data evaluation system 102 may refine its models based on the difference between the evaluation performed by data evaluation system 102 and the received feedback. For example, data evaluation system 102 may estimate a data set to be worth $10,000 but it may only sell for $8,000. In such cases, data evaluation system 102 may refine its models based on the $2,000 difference. To facilitate this functionality, data evaluation system 102 may include multiple training modes or modules including at least one for training the models of data evaluation system 102 using general transaction data and at least one for training the models of data evaluation system 102 based on transaction data for data sets previously evaluated by data evaluation system 102.

FIG. 2 is a block diagram illustrating an example implementation of data evaluation module 110 in further detail. As shown, in at least certain implementations, data evaluation module 110 may include a data set analyzer 156, one of more filters 152, a data pre-processor 154, data evaluation models 150, and a model trainer 158. The grouping of these elements into data evaluation module 110 is intended for clarity and should not be considered limiting. Stated differently, the various elements of data evaluation module 110 and their respective functions may be distributed differently or incorporated into other elements of data evaluation system 102 while still being within the scope of this disclosure.

During operation, data set analyzer 156 may receive/access a data set and perform a general analysis of the data set. For example, data set analyzer 156 may access a user data set stored in user data sets data source 106. Data set analyzer 156 may then extract various pieces of qualitative and quantitative information regarding the data set. As previously discussed, user data sets data source 106 may also store certain user-provided metadata for the data set. As further illustrated in FIG. 2, data evaluation module 110 may also receive data from external data source 122.

By way of example and without limitation, examples of data generated by data set analyzer 156 for user by data evaluation models 150 may include one or more of: a completeness metric for the data set, a cleanliness metric for the data set, a features set of the data set, a recency metric for the data set, a time range metric for the data set, a quantity metric for the data set, a quality or validation metric for the data set, a collection of elements for the data set, a uniqueness metric for the data set, and a data commonality metric for the data set.

In some cases, data evaluation system 102 may receive a data set in a format or accompanied by a file that includes summary data for the data set. In such cases, data set analyzer 156 may access and extract the summary data. In other implementations, data set analyzer 156 may include a series of processes or routines for analyzing the data set. For example, data set analyzer 156 may include processes for counting the number of records in the data set, identifying missing or incomplete records within the data set, assessing consistency across records of the data set, determining an age or time range for the data set, or determining whether records conform to one or more relevant criteria.

By way of example and without limitation, examples of metadata that may be provided by a user and on which data evaluation models 150 may rely include: an anticipated value of the evaluation metric, a cost to acquire the data set, a vertical or sector corresponding to the data set, a type of data for the data set, an annual gross revenue associated with the data set, an annual gross profit associated with the data set, and sales growth over time for the data set.

As previously noted, a user may be prompted to provide data evaluation system 102 with this data at various times. For example, in certain implementations, the user may be prompted for the foregoing data when uploading or initiating an evaluation of a given data set. In other implementations, the user may be prompted to provide at least some of the foregoing data upon creation of an account with data evaluation system 102, initial access of a website or portal corresponding to data evaluation system 102 or installation of an application for accessing data evaluation system 102.

By way of example and without limitation, examples of external data that may be obtained by data evaluation system 102 and on which data evaluation models 150 may rely include: a consumer price index value, a gross domestic product value, stock market data, and an interest rate. Data evaluation system 102 may be configured to automatically collect this data from external data sources (e.g., publicly accessible databases or news sources) using any suitable techniques (e.g., web scraping, API calls, etc.).

Data received by data evaluation module 110 may be filtered, e.g., by filter 152 and pre-processed, e.g., by data pre-processor 154, prior to being provided to data evaluation models 150. Implementations of this disclosure may rely on any suitable techniques for filtering and pre-processing data to prepare the data for use by data evaluation models 150; however, in at least certain implementations, filtering and pre-processing the data may include either of normalizing or scaling data values.

As previously discussed, data evaluation models 150 are generally configured to receive data set metadata, external data, and possibly the data set itself to generate an evaluation metric for the data set. The specific models included in data evaluation models 150 can vary; however, data evaluation models 150 may include various classifiers and/or regression models for evaluating data sets. By way of non-limiting example, data evaluation models 150 may include one or more of a linear regression, a polynomial regression, a classification tree, and a binomial tree. In at least certain implementations, output of data evaluation models 150 may be stored in evaluation data source 104 along with the associated metadata and external data corresponding to the evaluation.

As further shown in FIG. 2, data evaluation module 110 may also include model trainer 158, which receives transaction data and uses the transaction data as training data to update and modify data evaluation models 150. For example, model trainer 158 may be configured to periodically obtain updated transaction data and update one or more of data evaluation models 150 based on the updated transaction data.

Similarly, data evaluation module 110 may be configured to regenerate an evaluation metric in response to receiving updated metadata, external data, transaction data, other similar updates to the inputs and parameters of data evaluation models 150. For example, data evaluation module 110 may reevaluate a data set in response to receiving new interest rate or inflation data, new or revised transaction data from a data exchange, or changes to an evaluated data set. In certain implementations, evaluations may be rerun in response to an elapsed time (e.g., every day, every week, bi-monthly), a change in one or more of data evaluation models 150, a threshold number of changes to inputs and/or the data set being evaluated, receiving a request for an updated evaluation from a user, or any other similar criteria or event.

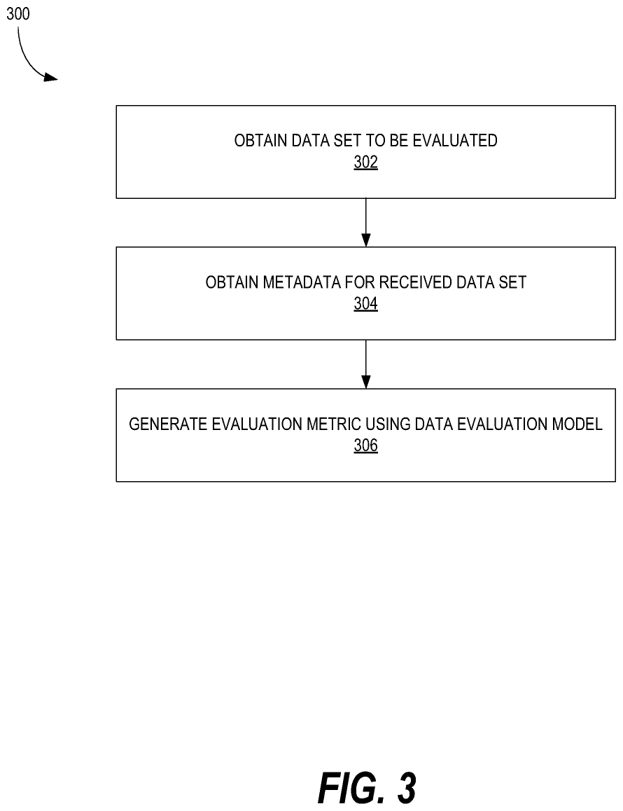

FIG. 3 illustrates an example method 300 for evaluating a data set. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, method 300 includes receiving a data set for evaluation (step 302). For example, data evaluation system 102 illustrated in FIG. 1 may receive data set data set 119 from data host system 114.

In certain implementations, receiving the data set may include data evaluation system 102 transmitting a request for the data set (or updates to a previously received data set) to data host system 114. Alternatively, data host system 114 may initiate an evaluation process by submitting a request and/or the data set to data evaluation system 102. Transmission of data sets (or data set updates) may be automatic (e.g., on a predetermined schedule) or may be manually initiated by a user associated with data host system 114.

Method 300 further includes obtaining metadata for the received data set (step 304). For example, after data evaluation system 102 obtains a data set, data evaluation system 102 may pass the data set to data set analyzer 156 of data evaluation module 110 (shown in FIG. 2). Data set analyzer 156 may then extract or generate values for various qualitative and quantitative features for the data set.

Metadata for a given data set may also include additional details and information about the data set that may be provided by a user associated with data host system 114, as discussed above.

Method 300 further includes generating an evaluation metric for the data set by providing the metadata to a data evaluation model (step 306). For example, data evaluation models 150 illustrated in FIG. 2 may receive as input the metadata generated during step 304 and may output an evaluation metric (e.g., a monetary valuation or score).

In certain implementations, the evaluation metric generated in step 306 may be a monetary valuation of the data set. In other implementations, the evaluation metric may be some other qualitative measure of the data set.

Generating the evaluation metric in step 306 may also be based on one or more pieces of external data, such as economic data. In such implementations, the data evaluation model may rely on features of the data set as captured in the metadata along with the external data to generate the evaluation metric. Collectively, the metadata, external data, and any portion of the data set provided to the data evaluation model form a set of input data for the data evaluation model, which outputs the evaluation metric based on the input data and the parameters of the data evaluation model.

As previously noted, at least a portion of the input data may be the result of filtering or other preprocessing data received by data evaluation system 102.

In at least certain implementations, method 300 may further include obtaining transaction information for one or more data sets and updating parameters of the data evaluation model based on the transaction information. For example, the transaction information may include one or more of metadata, external data, and samples of data sets subject to transactions on a data exchange or marketplace along with an evaluation metric value (e.g., a monetary value or rating) corresponding to the transaction. The transaction information may then be used to train the data evaluation model, such as by using the data characterizing the data set as a feature vector and the evaluation metric value as an output.

In at least certain implementations, data evaluation system 102 may be configured to re-execute method 300 in whole or in part to reevaluate data sets. For example, data evaluation system 102 may re-execute steps of method 300 in response to identifying changes or a threshold quantity of changes in data set records, data evaluation model parameters, input data, and the like. Alternatively, data evaluation system 102 may re-execute steps of method 300 on a periodic basis (e.g., daily, weekly, etc.) to update evaluations for data sets. In still other implementations, data evaluation system 102 may re-execute steps od method 300 in response to a request from a user, e.g., a user associated with data host system 114.

In the implementation illustrated in FIGS. 1 and 2, data evaluation system 102 is configured to receive a data set for evaluation. In certain circumstances, receiving data sets at data evaluation system 102 may not be feasible due to data security issues, or may be inefficient or costly due to the computing resources required to complete the transfer of the data or store the data in data evaluation system 102.

To address these issues, among others, implementations of this disclosure can have a distributed architecture in which the data evaluation system coordinates instances of models stored and executed locally by the data host systems. For example, the data evaluation system may maintain master versions of the data evaluation models and may provide periodic updates to the local models of the data host systems. The data evaluation system may also receive analyses and associated input data from the data host systems to validate and train the master version of the model maintained by the data evaluation system.

The distributed architecture of this disclosure provides several substantial benefits. From a data security perspective, the distributed architecture enables data host systems to perform data evaluations while remaining behind firewalls or implementing other security measures. Data can also be kept private with access required by the data host system only.

Even if data security is not a significant concern or an ancillary concern in a given implementation, the distributed architecture also provides improvements in resource usage and efficiency. For example, in the previously disclosed implementation, data evaluation system 102 receives copies of data sets or at least an initial copy of a data set and subsequent updates to the data set. Given the potential size of a data set, transfer of the entire data set or even just updates to the data set can require substantial bandwidth and processing resources. The cost, energy, memory, and processing resources required to maintain a data set can also be substantial. In contrast, the distributed architecture obviates the need to transfer the data set or updates by permitting data evaluation while requiring only a single instance of the data set in the data host system.

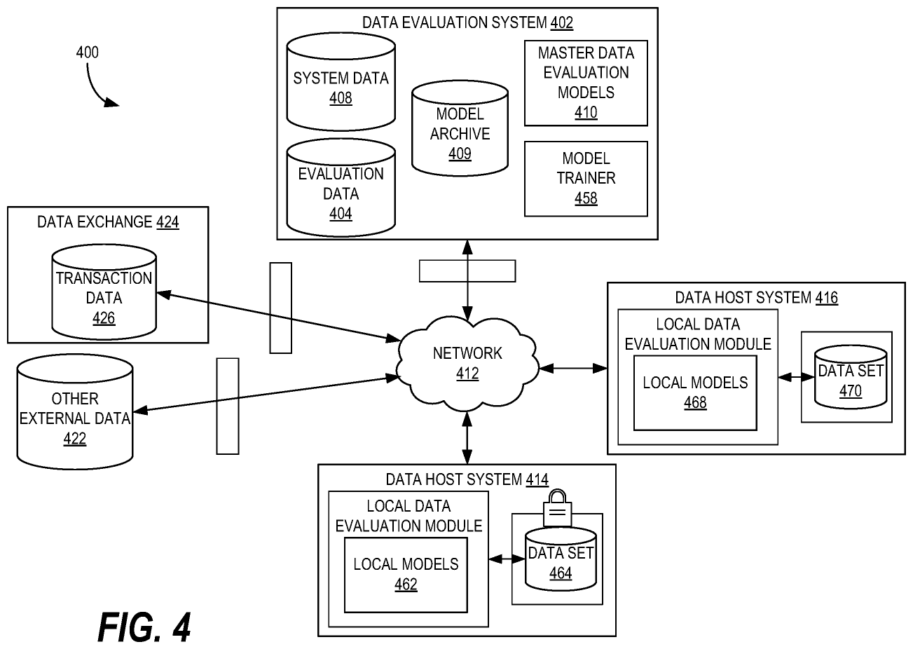

FIG. 4 is a diagram of an environment 400 illustrating a distributed implementation of the current disclosure. Environment 400 includes a data evaluation system 402 according to the present disclosure. As described below in further detail, data evaluation system 402 coordinates instances of data evaluation modules installed or otherwise executed locally by data host systems. For example, environment 400 includes data host system 414, which includes local data evaluation module 460, and data host system 416, which includes local data evaluation module 466, with each of the data host systems capable of communicating with data evaluation system 402 over a network 412, such as the Internet. Although environment 400 includes only data host system 414 and data host system 416, it should be appreciated that this disclosure contemplates systems including any number of data host systems, each of which may include one or more instances of local data evaluation modules.

Similar to data evaluation system 102 of FIG. 1, data evaluation system 402 may also include an evaluation data source 404 and system data source 408 for storing evaluation data and system data, respectively.

Local data evaluation module 460 and local data evaluation module 466 are configured to perform evaluation of locally stored data sets of their respective data host systems. For example, local data evaluation module 460 includes local models 462 that can be used to evaluate a data set 464 maintained by data host system 414 while local data evaluation module 466 includes local models 468, which can be used by local data evaluation module 466 to evaluate a data set 470 maintained by data host system 416. Notably, FIG. 4 illustrates data set 464 as being a “protected” data set that is inaccessible by computing systems outside of data host system 414. In other implementations, data host system 414 and/or data host system 416 may include a firewall or other security measures that protect the data host systems but that may preclude or impede the transfer of the data sets from the data host systems to data evaluation system 402.

While this disclosure generally refers to data set 464 and data set 470 as being “local” with respect to their corresponding data host systems; such language is intended to imply a logical, authorization, and/or ownership relationship between the data set and the data host system, not a geographic or physical relationship. So, for example, data set 464 is local to data host system 414 in the sense that data host system 414 has permission to access or is logically connected to data host system 414. That being said, data set 464 may be stored in physical media separate from computing elements executing other functions of data host system 414. For example, data set 464 may be maintained in a third-party cloud-based data storage system separate from other computing components of data host system 414.

In general, local data evaluation module 460 and local data evaluation module 466 operate similar to data evaluation module 110, shown in FIG. 2. Each is configured to receive some combination of metadata, external data, and, in some cases, portions of a data set. Each of local data evaluation module 460 and local data evaluation module 466 may include a data analyzer similar to data set analyzer 156 of data evaluation module 110 for extracting metadata from a data set. Each of local data evaluation module 460 and local data evaluation module 466 may also include filters and/or pre-processors for preprocessing data prior to analysis.

Similar to data evaluation module 110, each of local data evaluation module 460 and local data evaluation module 466 also includes respective data evaluation models. For example, local data evaluation module 460 is illustrated as including local models 462 while local data evaluation module 466 is illustrated as including local models 468. Although not shown, each of local data evaluation module 460 and local data evaluation module 466 may also include or otherwise have access to a data source for storing evaluation data, similar to evaluation data source 104 of data evaluation system 102 and system data, similar to system data source 108 of data evaluation system 102.

Each of local data evaluation module 460 and local data evaluation module 466 may also access or otherwise communicate with other data sources, e.g., over network 412. Examples of the other data sources may include a transaction data source 426 of a data exchange 424 or a source of external data 422, such as economic data. Alternatively, such data may be provided to data host system 414 and data host system 416 by data evaluation system 402 subsequent to data evaluation system 402 obtaining the data from the corresponding data sources.

To ensure that local models 462 and local models 468 are current, data evaluation system 402 maintains master data evaluation models 410 trained on transaction data obtained from transaction data source 426 or other sources of transaction data. More specifically, a model trainer 458 of data evaluation system 402 obtains training data and uses the training data to update parameters of master data evaluation models 410.

Data evaluation system 402 may also be configured to distribute updates to local instances of data evaluation models maintained by data host systems. For example, in response to a request to analyze a data set at data host system 414, local data evaluation module 460 may transmit a request for model updates to data evaluation system 402. Responsive to the request, data evaluation system 402 may access master data evaluation models 410 or a model archive 409 containing historical and/or current model parameter values and may transmit the most current parameters to local data evaluation module 460 to update local models 462. In other implementations, a data evaluation application or service executed on data host system 414 may be configured to request updated models from data evaluation system 402 during initialization or periodically over time. As yet another example, data evaluation system 402 may distribute updates to data host systems on a periodic basis and/or in response to changes in master data evaluation models 410.

Data evaluation system 402 may be configured to provide the most current model parameters in response to a request from data host systems, on a periodic basis, as part of a startup process for an application corresponding to data evaluation system 402, etc. In certain implementations, data evaluation system 402 may optionally perform a version check or similar operation to determine whether an update is needed prior to transmitting the update to the requesting data host system. For example, data evaluation models may be assigned a version identifier or timestamp indicating the last time a model was updated. When requesting a model update, data host system 414 may include the model version or timestamp of its data evaluation models and data evaluation system 402 may determine whether the provided version identified or timestamp corresponds to the most current version of the master data evaluation models. If so, data evaluation system 402 may forego transmitting an update to data host system 414 or transmit a message or indicator communicating that the data evaluation models of data host system 414 are up to date.

Data host systems including instances of local data evaluation modules may be configured to transmit evaluation data to data evaluation system 402. Such data may include metadata values, external data values, and evaluation metrics generated by the local data evaluation modules. In at least certain implementations, the evaluation data excludes any actual records of the evaluated data set, thereby maintaining privacy and security of the data set and/or improving system efficiency. Subsequent to receiving evaluation data from a data host system, model trainer 458 of data evaluation system 402 may update master data evaluation models 410 based on the received data.

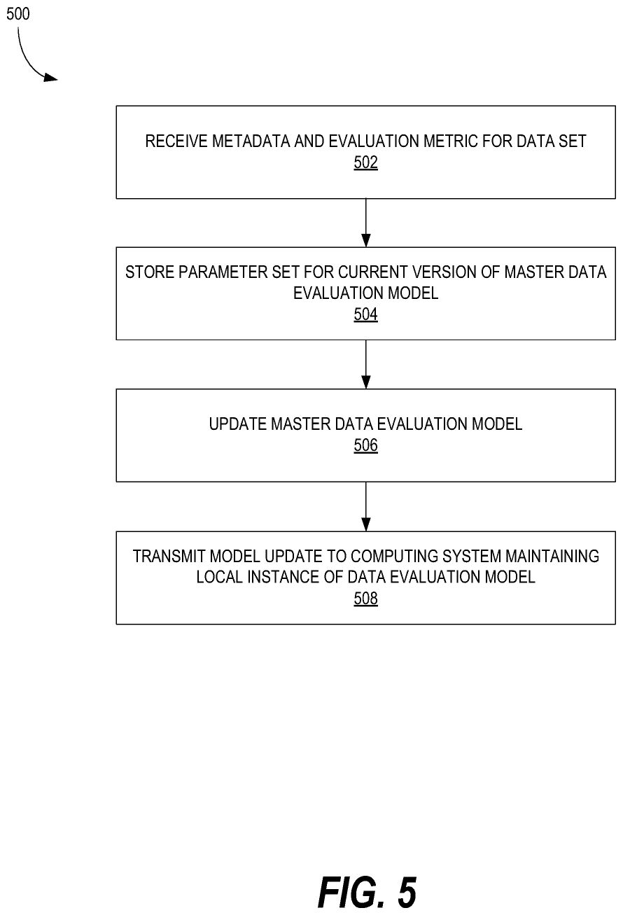

FIG. 5 is a flow chart illustrating a method 500 for updating data evaluation models, such as master data evaluation models 410 of FIG. 4. For purposes of clarity, method 500 is discussed below with reference to elements of FIG. 4; however, it should be understood that any reference to such elements is intended as an explanatory example only method 500 is not limited to the specific implementation illustrated in FIG. 4.

At step 502, a first computing system receives metadata for a data set and a corresponding evaluation metric for the data set from a second computing system, the evaluation metric being generated by a data evaluation model maintained by the second computing system. For example, data evaluation system 402 receives data from data host system 414 including metadata for data set 464 and an evaluation metric for data set 464 generated by local models 462 of local data evaluation module 460. As noted above, local models 462 are instances of master data evaluation models 410 maintained by data evaluation system 402.

At step 504, the first computing system may optionally store a current parameter set of the master version of the data evaluation models. Among other things, doing so permits recreation of historic analyses and can permit rollbacks of the data evaluation models. In the context of FIG. 4, for example, data evaluation system 402 may store parameters of master data evaluation models 410 in model archive 409. In certain implementations, each set of model parameters may include supplemental data, such as a timestamp.

Subsequent to storing a parameter set, data evaluation system 402 may be configured to receive a request for a historic version of master data evaluation models 410. In response, data evaluation system 402 may access archive 409 to retrieve the parameter set associated with the request and transmit the historic parameter set accordingly.

Data evaluation system 402 may also be configured to receive a request for an evaluation metric of a data set based on a historic versions of master data evaluation models 410 and corresponding input data. In response, data evaluation system 402 may access historic model parameters stored in archive 409 and generate and execute one or more of master data evaluation models 410 using the input data and based on the historic parameter set.

At step 506, the first computing system updates one or more parameters of a master of the data evaluation model maintained in the first computing system. For example, data evaluation system 402 updates one or more parameters of a model included in master data evaluation models 410 based on transaction data received from a data exchange or similar source of feedback.

In certain cases, the update of step 506 may be in response to data evaluation system 402 receiving transaction data for a data set other than the data set for which data was received in step 502. For example, the transaction data may correspond to a data set maintained by a data host system other than data host system 414 or may be for a data set independent of any data host system associated with data evaluation system 402. In other cases, the transaction data may be for the data set of step 502. In such cases, the update of step 506 may be based on the transaction data as received or may be based on a difference between the transaction data and the evaluation metric included in the data received in step 502.

At step 508 and subsequent to updating the master version of the data evaluation model, the first computing system transmits an updated model parameter to a third computing system, which may or may not be the same as the second computing system discussed above. With reference to environment 400, after updating master data evaluation models 410, data evaluation system 402 may transmit updates for local models to one or more host data systems maintaining local instances of master data evaluation models 410 for application to the local models.

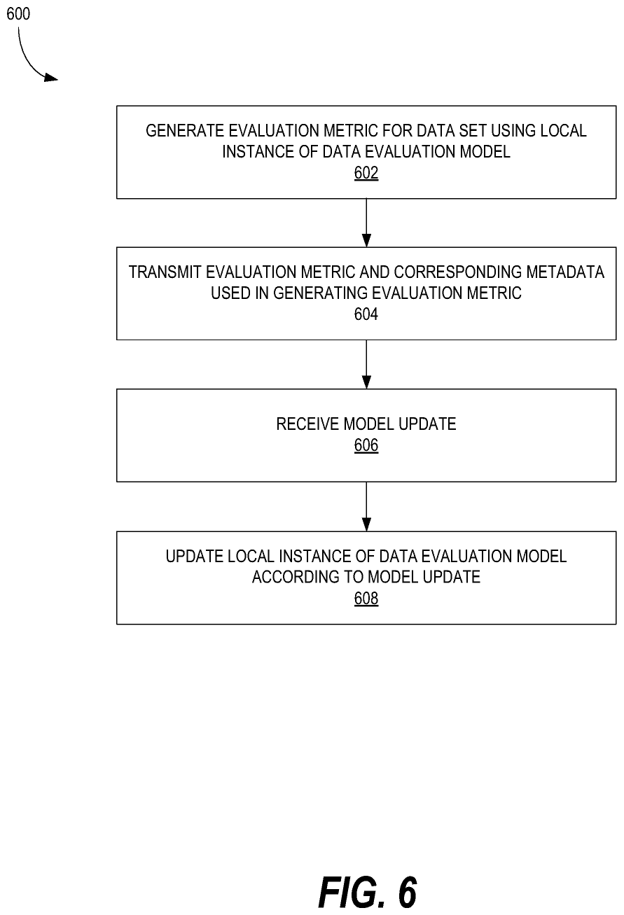

FIG. 6 is another flowchart of a method 600 for updating data evaluation models. In contrast to method 500, which was generally from the perspective of a data evaluation system maintaining a master version of a data evaluation model, method 600 is primarily from the perspective of a host data system, such as data host system 414. Similar to the foregoing description of method 500, the following description of method 600 references elements of environment 400 but should not be limited to implementation illustrated in FIG. 4.

At step 602, a first computing system generates an evaluation metric for a data set. The first computing system generates the evaluation metric using a data evaluation model that is a local instance of a master data evaluation model maintained by a second computing system. With reference to environment 400, data host system 414 executes local data evaluation module 460 which generates an evaluation metric for data set 464 using local models 462. As previously noted, local models 462 is generally a local instance of master data evaluation models 410, which are stored and maintained by data evaluation system 402.

At step 604, the first computing system transmits the evaluation metric and corresponding metadata for the data set to the second computing system. Subsequent to receiving the evaluation metric and the metadata, the second computing system updates the master version of the data evaluation model. So, for instance, data host system 414 transmits an evaluation metric and metadata for data set 464 to data evaluation system 402. After receiving the evaluation metric and metadata, data evaluation system 402 receives transaction data or other feedback and provides the feedback to model trainer 458 which updates master data evaluation models 410.

As previously noted, certain data evaluation models may rely on external data, such as economic data, when evaluating a given data set. In such cases, a data host system may also include the external data when providing the evaluation metric to data evaluation system 402. The host data system may also provide some or all of the evaluated data set, provided the data set is not protected or otherwise private.

At step 606 and subsequent to the transmission of step 604, the first computing system receives a model update from the second computing system. With reference to FIG. 4, data host system 414 may receive a model update from data evaluation system 402. In certain implementations, the model update includes updated parameter values for one or more of local models 462 maintained by local data evaluation module 460 of data host system 414.

Notably, the first computing system may receive a model update from the second computing system in direct response to the transmitting of step 604. Alternatively, step 606 may occur as part of an update process executed by the second computing device and in which the second computing system distributes an updated version of the master data evaluation model to one or more data host systems including the first computing system. As yet another alternative, step 606 may occur in response to the first computing system requesting the model update from the second computing system.

At step 608, the first computing system applies the model update to the local instance of the data evaluation model, thereby updating the local instance to reflect the updated master version of the model maintained by the second computing system. For example, data host system 414 may apply the updated model parameter values received in step 606 to local models 462, thereby updating local models 462 to reflect the current state of master data evaluation models 410 maintained by data evaluation system 402.

In the previously discussed implementations, model updates generally occurred first to the master data evaluation modules at the central data evaluation system. The updates were subsequently promulgated to other data host systems for application to their respective local models. However, this disclosure also contemplates that model updates may also occur at the data host systems. For example, each data host system may include a model trainer, similar to model trainer 158 of FIG. 2, and may be configured to receive feedback (e.g., transaction data from a data exchange). The model trainer may then train the local models based on the feedback.

In certain implementations, any changes to the local models for a given data host system may be limited to the data host system such that the data host system gradually develops its own set of unique models. In such cases, updates from the central data evaluation system may not be received or applied by the data host system to preserve its models. Alternatively, the data host system may be configured to overwrite any local models with updates received from the data evaluation system.

In still other implementations, the data host systems may be configured to update their local models and to communicate any such updates back to the central data evaluation system. The data evaluation system may then apply the updates to its master data evaluation models and promulgate the updates to other data host systems as previously discussed.

In implementations in which data evaluation system receives updates from data host systems, data evaluation system may be configured to selectively apply conflicting updates according to various policies. For example, data evaluation system may disregard changes to certain parameters when received updates conflict (e.g., one update from a first data host system increases a weighting or parameter value while another update from a second data host system decreases the weighting or parameter value). As another example, the data evaluation system may evaluate each received update and implement the update that results in more accurate predictions/evaluation metrics. To do so, data evaluation system may maintain a set of test data and corresponding feedback, execute models according to each update using the test data, and determine which update results in the most improvement over the current master version of the data evaluation models. Notably, if an update fails to improve the current mast versions of the data evaluation models, the data evaluation model may be configured to disregard the update.

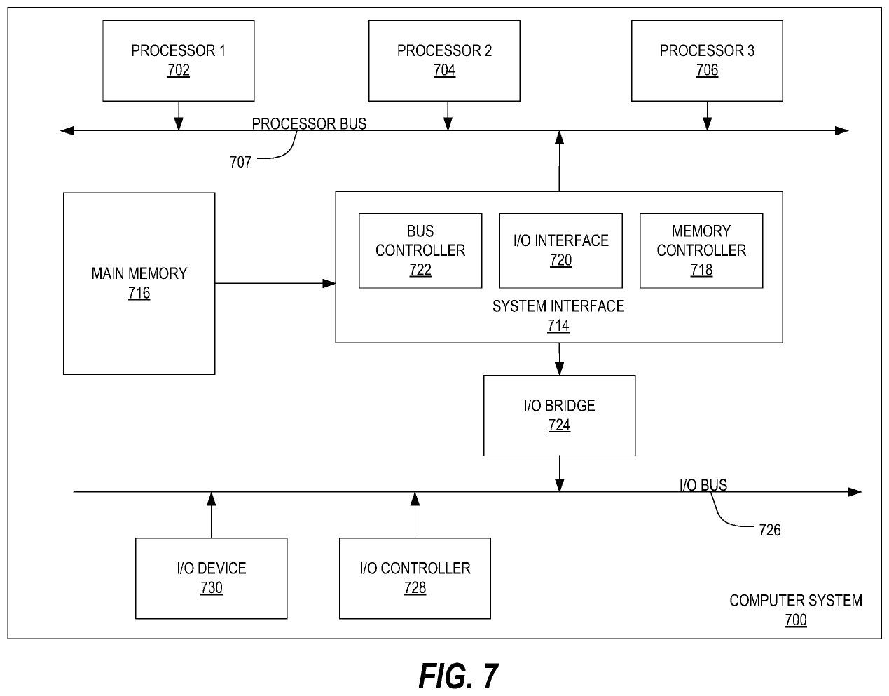

FIG. 7 is a block diagram illustrating an example of a computing device or computer system 700 which may be used in implementations of the present disclosure. In particular, the computing device of FIG. 7 is one embodiment of any of the devices that perform one of more of the operations described above.

The computer system 700 includes one or more processors 702-706. Processors 702-706 may include one or more internal levels of cache (not shown) and a bus controller 722 or bus interface unit to direct interaction with the processor bus 707. Processor bus 707, also known as the host bus or the front side bus, may be used to couple the processors 702-706 with the system interface 714. System interface 714 may be connected to the processor bus 707 to interface other components of the system 700 with the processor bus 707. For example, system interface 714 may include a memory controller 718 for interfacing a main memory 716 with the processor bus 707. The main memory 716 typically includes one or more memory cards and a control circuit (not shown). System interface 714 may also include an input/output (I/O) interface 720 to interface one or more I/O bridges (e.g., I/O bridge 724) or I/O devices with the processor bus 707. One or more I/O controllers and/or I/O devices may be connected with the I/O bus 726, such as I/O controller 728 and I/O device 730, as illustrated.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

System 700 may include a dynamic, non-transitory storage device, referred to as main memory 716, or a random access memory (RAM) or other computer-readable devices coupled to the processor bus 707 for storing information and instructions to be executed by the processors 702-706. Main memory 716 also may be used for tangibly storing temporary variables or other intermediate information during execution of instructions by the processors 702-706. System 700 may include a read only memory (ROM) and/or other static storage device coupled to the processor bus 707 for storing static information and instructions for the processors 702-706. The system set forth in FIG. 7 is but one possible example of a computer system that may employ or be configured in accordance with aspects of the present disclosure.

According to one implementation, the above techniques may be performed by computer system 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 716. Common forms of a machine-readable media may include, but is not limited to, magnetic storage media; optical storage media (e.g., CD-ROM); magneto-optical storage media; read only memory (ROM); random access memory (RAM); erasable programmable memory (e.g., EPROM and EEPROM); flash memory; or other types of media suitable for storing electronic instructions.

Embodiments of the present disclosure include various operations, which are described in this specification. The steps may be performed by hardware components or may be embodied in machine-executable instructions, which may be used to cause a general-purpose or special-purpose processor programmed with the instructions to perform the operations. Alternatively, the operations may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method comprising:
obtaining historical transaction data at a first computing system from an external data marketplace, wherein the first computing system maintains a master of a data evaluation model and the historical transaction data is obtained through a first application programming interface (API);
training the master of the data evaluation model at the first computing system using the historical transaction data to generate an update to the master of the data evaluation model;
subsequent to generating the update to the master of the data evaluation model, distributing the update to the data evaluation model from the first computing system through a second API to one or more computing systems maintaining local instances of the data evaluation model, wherein:
the data evaluation model is configured to receive as input, a feature vector including metadata characterizing a data set and to generate an evaluation metric for the data set based on the feature vector,
the evaluation metric is a monetary or non-monetary score for the data set, and
the update includes a change in a parameter of the data evaluation model,
wherein, when the update is received through the second API by a second computing system maintaining an instance of the data evaluation model previously provided by the first computing system, the update causes the second computing system to apply the change to the parameter in the instance of the data evaluation model, and
wherein the instance of the data evaluation model is independently executable at the second computing system to generate evaluation metrics for a protected data set maintained by the second computing system and to provide at least one of metadata corresponding to the protected data set and the evaluation metrics generated by the instance of the data evaluation model to the first computing system without transmitting a portion of the protected data set to the first computing system.

2. The computer-implemented method of claim 1 further comprising receiving metadata characterizing one or more data sets and evaluation metrics for each of the one or more data sets, wherein training the master of the data evaluation model is further based on the metadata and the evaluation metrics.

3. The computer-implemented method of claim 1, wherein the historical transaction data includes metadata characterizing one or more data sets associated with prior transactions of the external data marketplace and evaluation metrics for each of the one or more data sets.

4. The computer-implemented method of claim 1, wherein:
the data evaluation model includes a data set-independent parameter,
the computer-implemented method further comprises obtaining a value for the data set-independent parameter, and
training the master of the data evaluation model is further based on the value for the data set-independent parameter.

5. The computer-implemented method of claim 1, further comprising generating a record including a timestamp and parameter values for the master of the data evaluation model prior.

6. The computer-implemented method of claim 1, further comprising:
receiving a request for a previous version of the master of the data evaluation model;
accessing an archive including parameter sets for the master of the data evaluation model including a parameter set for the previous version of the master of the data evaluation model; and
transmitting the parameter set for the previous version of the data evaluation model.

7. The computer-implemented method of claim 1, further comprising receiving a request for the update to the data evaluation model from the second computing system, wherein transmitting the update to the data evaluation model is in response to receiving the request.

8. A computing system comprising:
one or more data processors; and
a non-transitory computer-readable storage medium containing instructions which, when executed by the one or more data processors, cause the one or more data processors to perform operations including:
obtaining historical transaction data at the computing system from an external data marketplace, wherein the computing system maintains a master of a data evaluation model and the historical transaction data is obtained through a first application programming interface (API);
training the master of the data evaluation model at the computing system using the historical transaction data to generate an update to the master of the data evaluation model;
subsequent to generating the update to the master of the data evaluation model, distributing the update to the data evaluation model from the computing system through a second API to one or more computing systems maintaining local instances of the data evaluation model, wherein:
the data evaluation model is configured to receive as input, a feature vector including metadata characterizing a data set and to generate an evaluation metric for the data set based on the feature vector,
the evaluation metric is a monetary or non-monetary score for the data set, and
the update includes a change in a parameter of the data evaluation model,
wherein, the update is configured such that when the update is received through the second API by a second computing system maintaining an instance of the data evaluation model previously provided by the computing system, the update causes the second computing system to apply the change to the parameter in the instance of the data evaluation model, and
wherein the instance of the data evaluation model is independently executable at the second computing system to generate evaluation metrics for a protected data set maintained by the second computing system and to provide at least one of metadata corresponding to the protected data set and the evaluation metrics generated by the instance of the data evaluation model to the first computing system without transmitting a portion of the protected data set to the computing system.

9. The computing system of claim 8, wherein the operations further include receiving metadata characterizing one or more data sets and evaluation metrics for each of the one or more data sets, wherein training the master of the data evaluation model is further based on the metadata and the evaluation metrics.

10. The computing system of claim 8, wherein the historical transaction data includes metadata characterizing one or more data sets associated with prior transactions of the external data marketplace and evaluation metrics for each of the one or more data sets.

11. The computing system of claim 8, wherein:
the data evaluation model includes a data set-independent parameter, and
the operations further include obtaining a value for the data set-independent parameter, and
training the master of the data evaluation model is further based on the value for the data set-independent parameter.

12. The computing system of claim 8, wherein the operations further include generating a record including a timestamp and parameter values for the master of the data evaluation model prior.

13. The computing system of claim 8, wherein the operations further include:
receiving a request for a previous version of the master of the data evaluation model;
accessing an archive including parameter sets for the master of the data evaluation model including a parameter set for the previous version of the master of the data evaluation model; and
transmitting the parameter set for the previous version of the data evaluation model.

14. The computing system of claim 8, wherein the operations further include receiving a request for the update to the data evaluation model from the second computing system, wherein transmitting the update to the data evaluation model is in response to receiving the request.

15. A computer-program product tangibly embodied in a non-transitory machine-readable storage medium, including instructions configured to cause a computing system to perform operations including:
obtaining historical transaction data at the computing system from an external data marketplace, wherein the computing system maintains a master of a data evaluation model and the historical transaction data is obtained through a first application programming interface (API);
training the master of the data evaluation model at the computing system using the historical transaction data to generate an update to the master of the data evaluation model;
subsequent to generating the update to the master of the data evaluation model, distributing the update to the data evaluation model from the computing system through a second API to one or more computing systems maintaining local instances of the data evaluation model, wherein:
the data evaluation model is configured to receive as input, a feature vector including metadata characterizing a data set and to generate an evaluation metric for the data set based on the feature vector,
the evaluation metric is a monetary or non-monetary score for the data set, and
the update includes a change in a parameter of the data evaluation model,
wherein, the update is configured such that when the update is received through the second API by a second computing system maintaining an instance of the data evaluation model previously provided by the computing system, the update causes the second computing system to apply the change to the parameter in the instance of the data evaluation model, and
wherein the instance of the data evaluation model is independently executable at the second computing system to generate evaluation metrics for a protected data set maintained by the second computing system and to provide at least one of metadata corresponding to the protected data set and the evaluation metrics generated by the instance of the data evaluation model to the first computing system without transmitting a portion of the protected data set to the computing system.

16. The computer-program product of claim 15, wherein the operations further include receiving metadata characterizing one or more data sets and evaluation metrics for each of the one or more data sets, wherein training the master of the data evaluation model is further based on the metadata and the evaluation metrics.

17. The computer-program product of claim 15, the historical transaction data includes metadata characterizing one or more data sets associated with prior transactions of the external data marketplace and evaluation metrics for each of the one or more data sets.

18. The computer-program product of claim 15, wherein the operations further include:
receiving a request for a previous version of the master of the data evaluation model;
accessing an archive including parameter sets for the master of the data evaluation model including a parameter set for the previous version of the master of the data evaluation model; and
transmitting the parameter set for the previous version of the data evaluation model.

19. The computer-program product of claim 15, wherein the operations further include receiving a request for the update to the data evaluation model from the second computing system, wherein transmitting the update to the data evaluation model is in response to receiving the request.

20. The computer-program product of claim 15, wherein the operations further include:
receiving a request for a previous version of the master of the data evaluation model;
accessing an archive including parameter sets for the master of the data evaluation model including a parameter set for the previous version of the master of the data evaluation model; and
transmitting the parameter set for the previous version of the data evaluation model.
